(19) United States
(12) Patent Application Publication
(10) Pub. No.: US 2026/0231261 A1
(43) Pub. Date: Aug. 6, 2026

(54) SSB-LESS SCELL ACTIVATION INDICATION

(71) Applicant: Nokia Technologies Oy, Espoo (FI)

(72) Inventors: Lars Dalsgaard, Oulu (FI); Lei Du, Beijing (CH)

(73) Assignee: Nokia Technologies Oy, Espoo (FI)

(21) Appl. No.: 19/154,517

(22) PCT Filed: Feb. 8, 2023
(86) PCT No.: PCT/CN2023/075047

§ 371 Date: Aug. 7, 2025

(51) Int. Cl. H04W 76/15

(52) U.S. Cl. CPC H04W 76/15

(57) ABSTRACT

An apparatus may be configured to: receive an indication to activate at least one secondary cell; determine whether one or more conditions for activation of the at least one secondary cell are met; and in response to a determination that at least one of the one or more conditions is not met, transmit an activation status indication with respect to the at least one secondary cell. An apparatus may be configured to: transmit, to a user equipment, an indication to activate at least one secondary cell; and receive, from the user equipment, an activation status indication with respect to the at least one secondary cell.

### BACKGROUND

It is known, in network communication, to use carrier aggregation.

### FIELD OF EMBODIMENTS

The example and non-limiting embodiments relate generally to secondary cell or secondary cell group (SCG) activation and, more particularly, to activation without a synchronization signal block configuration.

### BRIEF SUMMARY OF EMBODIMENTS

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: receive an indication to activate at least one secondary cell; determine whether one or more conditions for activation of the at least one secondary cell are met; and in response to a determination that at least one of the one or more conditions is not met, transmit an activation status indication with respect to the at least one secondary cell.

In accordance with one aspect, a method comprising: receiving, with a user equipment, an indication to activate at least one secondary cell; determining whether one or more conditions for activation of the at least one secondary cell are met; and in response to a determination that at least one of the one or more conditions is not met, transmitting an activation status indication with respect to the at least one secondary cell.

In accordance with one aspect, an apparatus comprising means for performing: receiving an indication to activate at least one secondary cell; determining whether one or more conditions for activation of the at least one secondary cell are met; and in response to a determination that at least one of the one or more conditions is not met, transmitting an activation status indication with respect to the at least one secondary cell.

In accordance with one aspect, a non-transitory computer-readable medium comprising program instructions stored thereon for performing at least the following: causing receiving of an indication to activate at least one secondary cell; determining whether one or more conditions for activation of the at least one secondary cell are met; and in response to a determination that at least one of the one or more conditions is not met, causing transmitting of an activation status indication with respect to the at least one secondary cell.

In accordance with one aspect, an apparatus comprising: at least one processor; and at least one memory storing instructions that, when executed by the at least one processor, cause the apparatus at least to: receive an indication to activate at least one SCG; determine whether one or more conditions for activation of the at least one SCG are met; and in response to a determination that at least one of the one or more conditions is not met, transmit an activation status indication with respect to the at least one SCG. The SCG may comprise a Primary SCell (PSCell).

In accordance with one aspect, a method comprising: receiving, with a user equipment, an indication to activate at least one SCG; determining whether one or more conditions for activation of the at least one SCG are met; and in response to a determination that at least one of the one or more conditions is not met, transmitting an activation status indication with respect to the at least one SCG. The SCG may comprise a PSCell.

In accordance with one aspect, an apparatus comprising means for performing: receiving an indication to activate at least one SCG; determining whether one or more conditions for activation of the at least one SCG are met; and in response to a determination that at least one of the one or more conditions is not met, transmitting an activation status indication with respect to the at least one SCG. The SCG may comprise a PSCell.

In accordance with one aspect, a non-transitory computer-readable medium comprising program instructions stored thereon for performing at least the following: causing receiving of an indication to activate at least one SCG; determining whether one or more conditions for activation of the at least one SCG are met; and in response to a determination that at least one of the one or more conditions is not met, causing transmitting of an activation status indication with respect to the at least one SCG. The SCG may comprise a PSCell.

In accordance with one aspect, an apparatus comprising: at least one processor; and at least one memory storing instructions that, when executed by the at least one processor, cause the apparatus at least to: receive an indication to activate at least one secondary cell/SCG; determine whether one or more conditions for activation of the at least one secondary cell/SCG are met; and in response to a determination of a status of at least one of the one or more conditions, transmit an activation status indication with respect to the at least one secondary cell/SCG. The SCG may comprise a PSCell.

In accordance with one aspect, a method comprising: receiving, with a user equipment, an indication to activate at least one secondary cell/SCG; determining whether one or more conditions for activation of the at least one secondary cell/SCG are met; and in response to a determination of a status of at least one of the one or more conditions, transmitting an activation status indication with respect to the at least one secondary cell/SCG. The SCG may comprise a PSCell.

In accordance with one aspect, an apparatus comprising means for performing: receiving an indication to activate at least one secondary cell/SCG; determining whether one or more conditions for activation of the at least one secondary cell/SCG are met; and in response to a determination of a status of at least one of the one or more conditions, transmitting an activation status indication with respect to the at least one secondary cell/SCG. The SCG may comprise a PSCell.

In accordance with one aspect, a non-transitory computer-readable medium comprising program instructions stored thereon for performing at least the following: causing receiving of an indication to activate at least one secondary cell/SCG; determining whether one or more conditions for activation of the at least one secondary cell/SCG are met; and in response to a determination of a status of at least one of the one or more conditions, causing transmitting of an activation status indication with respect to the at least one secondary cell/SCG. The SCG may comprise a PSCell.

In accordance with one aspect, an apparatus comprising: at least one processor; and at least one memory storing instructions that, when executed by the at least one processor, cause the apparatus at least to: transmit, to a user equipment, an indication to activate at least one secondary cell; and receive, from the user equipment, an activation status indication with respect to the at least one secondary cell.

In accordance with one aspect, a method comprising: transmitting, to a user equipment, an indication to activate at least one secondary cell; and receiving, from the user equipment, an activation status indication with respect to the at least one secondary cell.

In accordance with one aspect, an apparatus comprising means for performing: transmitting, to a user equipment, an indication to activate at least one secondary cell; and receiving, from the user equipment, an activation status indication with respect to the at least one secondary cell.

In accordance with one aspect, a non-transitory computer-readable medium comprising program instructions stored thereon for performing at least the following: causing transmitting, to a user equipment, of an indication to activate at least one secondary cell; and causing receiving, from the user equipment, of an activation status indication with respect to the at least one secondary cell.

In accordance with one aspect, an apparatus comprising: at least one processor; and at least one memory storing instructions that, when executed by the at least one processor, cause the apparatus at least to: transmit, to a user equipment, an indication to activate at least one SCG; and receive, from the user equipment, an activation status indication with respect to the at least one SCG. The SCG may comprise a PSCell.

In accordance with one aspect, a method comprising: transmitting, to a user equipment, an indication to activate at least one SCG; and receiving, from the user equipment, an activation status indication with respect to the at least one SCG. The SCG may comprise a PSCell.

In accordance with one aspect, an apparatus comprising means for performing: transmitting, to a user equipment, an indication to activate at least one SCG; and receiving, from the user equipment, an activation status indication with respect to the at least one SCG. The SCG may comprise a PSCell.

In accordance with one aspect, a non-transitory computer-readable medium comprising program instructions stored thereon for performing at least the following: causing transmitting, to a user equipment, of an indication to activate at least one SCG; and causing receiving, from the user equipment, of an activation status indication with respect to the at least one SCG. The SCG may comprise a PSCell.

According to some aspects, there is provided the subject matter of the independent claims. Some further aspects are defined in the dependent claims.

### BRIEF DESCRIPTION OF THE SEVERAL VIEWS OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a flowchart illustrating steps as described herein;

FIG. 4 is a flowchart illustrating steps as described herein;

FIG. 5 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
6G sixth generation
AGC automatic gain control
AMF access and mobility management function
CA carrier aggregation
CBM independent beam management
CP cyclic prefix
CRAN cloud radio access network
CU central unit
CSI channel status report
CSI-RS channel state information reference signal
D2D device-to-device
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
FR1 frequency range 1
FR2 frequency range 2
gNB (or gNodeB) base station for 5G/NR, i.e., a node providing NR user plane and control plane protocol terminations towards the UE, and connected via the NG interface to the 5GC
I/F interface
IoT Internet of Things
L1 layer 1
L1-RSRP RSRP measured according to L1 rules
LTE long term evolution
MAC medium access control
MCG master cell group
MME mobility management entity
MRTD maximum receive time difference
ng or NG new generation
ng-eNB or NG-eNB new generation eNB
NR new radio
N/W or NW network
O-RAN open radio access network
PBCH physical broadcast channel
PCell primary cell
PDCP packet data convergence protocol
PHY physical layer
PL path loss
ProSe proximity service
QCL quasi co-location
RAN radio access network
RF radio frequency
RLC radio link control
RRC radio resource control
RRH remote radio head
RRM radio resource management
RS reference signal
RSRP reference signal received power
RTD receive time difference
RU radio unit
Rx receiver
SCell secondary cell
SCG secondary cell group
SDAP service data adaptation protocol
SGW serving gateway
SL sidelink
SMF session management function
SMTC SS/PBCH block measurement timing configuration
SNR signal to noise ratio
SSB synchronization signal block
SS-RSRP RSRP based on SSB
TP throughput
TRP transmission point
Tx transmitter
UE user equipment (e.g., a wireless, typically mobile device)
UPF user plane function
V2I vehicle to infrastructure
V2N vehicle to network
V2P vehicle to pedestrian
V2V vehicle to vehicle
V2X vehicle to everything
VNR virtualized network function

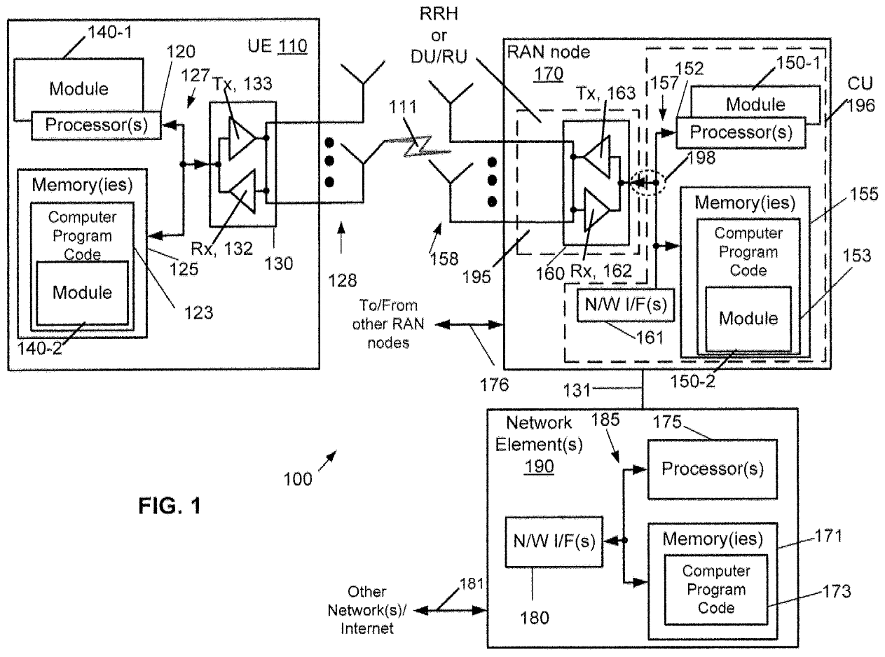

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The UE 110 may be capable of sidelink communication with other UEs in addition to network communication or if wireless communication with a network is unavailable or not possible. For example, the UE 110 may perform sidelink communication with another UE which may include some or all of the features of UE 110, and/or may include additional features. Optionally, the UE 110 may also communicate with other UEs via short range communication technologies, such as Bluetooth®.

The RAN node 170 in this example is a base station that provides access by wireless devices such as the UE 110 to the wireless network 100. The RAN node 170 may be, for example, a base station for 5G, also called New Radio (NR), and/or 5G-Advanced (i.e. NR Rel-18 and beyond) and/or 6G. In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. In addition, various embodiments of the user equipment 110 can include, but are not limited to, devices integrated into vehicles, infrastructure associated with vehicular travel, wearable devices used by pedestrians or other non-vehicular users of roads, user equipment unrelated to traffic users, and user equipment configured to participate in sidelink scenarios, such as public safety user equipment and/or other commercial user equipment.

Having thus introduced one suitable but non-limiting technical context for the practice of the example embodiments of the present disclosure, example embodiments will now be described with greater specificity.

Features as described herein generally relate to network synchronization signal block-less (SSB-less) secondary cell (SCell) and/or secondary cell group (SCG) operation. Features as described herein may also be applicable to SSB-less Primary SCell (PSCell). However, features as described herein may also be applied for other scenarios (e.g. the secondary cell or PSCell activation with SSB); example embodiments of the present disclosure are not limited to SSB-less SCell operation. In R18, the WI for Network energy savings for NR was approved in RP-223540 at RAN #98, wherein one of the objectives is to specify SSB-less SCell operation for inter-band carrier aggregation (CA) for FR1 co-located cells, as in Section 4.1:
“ . . . Specify SSB-less SCell operation for inter-band CA for FR1 and co-located cells, if found feasible by RAN4 study, where a UE measures SSB transmitted on PCell or another SCell for an SCell's time/frequency synchronization (including downlink AGC), and L1/L3 measurements, including potential enhancement on SCell activation procedures if necessary [RAN4, RAN2] . . . ”

RAN1 has evaluated the proposals for network energy savings in the study phase, and the results are captured in the technical report TR38.864 v0.5.0 (R1-2213007). With regard to SSB-less operation, the idea is to reuse the current SCell without SSB requirements defined for intra-band scenario as the baseline. In this scenario, RAN4 has defined UE behavior and requirements, and these are based on the assumption that the UE can do the time and frequency synchronization from the other serving cell and does not need to acquire these for the intended/new/target/to be activated SCell. These requirements have been defined, and only apply under some specific conditions.

Based on the current RAN4 requirements, RAN1 has following assumption captured in the TR for network energy savings (TR38.864 6.1.6.4 higher layer procedures):
“ . . . The SCell without SSB in intra-band CA is considered as baseline, i.e., for a serving cell without transmission of SS/PBCH blocks, a UE acquires time and frequency synchronization with the serving cell based on receptions of SS/PBCH blocks on the SpCell or the SCell, of the cell group.
More detailed discussion on higher layer procedures for RAN2 may be needed in WI phase according to the other WGs input . . . ”

As the WI considers inter-band CA for FR1, it is clear that what is discussed is an SCell which is non-contiguous in frequency to the active serving cell (e.g. PCell).

Features as described herein may relate to the SCell activation delay requirement for a collocated SSB-less SCell for inter-band CA. However, example embodiments of the present disclosure are not limited to FR1 and co-located cells, and may be extended to FR2 or non-co-located cells.

In existing specification TS38.133, SCell activation delay requirement is defined for SSB-less Intra-band contiguous SCell. As cited below (TS38.133 clause 8.3.2, which defines the SCell activation requirement for intra-band SSB-less SCell), only 3 ms is needed to activate an intra-band contiguous SSB-less SCell, as the UE assumes the same timing, beam information, and channel propagation conditions with PCell. Hence, no dedicated activation steps may be needed for the SCell. The UE may blindly rely on the network using exactly the same configuration and timing of PCell. Applying this assumption, the UE would start using the SCell.
“ . . . If the SCell being activated belongs to FR1 and if there is at least one active serving cell contiguous to the SCell on that FR1 band, if the UE is not provided with SSB configuration (absoluteFrequencySSB) nor SMTC configuration for the target SCell, Tactivation_time is 3 ms for UE supporting scellWithoutSSB, provided
The RTD between the target SCell and the contiguous active serving cell is within within ±260 ns, and
The difference of the reception power with the contiguous active serving cell is <=6 dB, and
The RS(s) of SCell being activated is (are) QCL-TypeA with TRS(s) of the SCell being activated, and the TRS(s) of the SCell being activated is (are) further QCL-TypeC with SSB(s) of any active serving cell that is contiguous to the SCell being activated on that FR1 band . . . ”

However, this requirement is defined under a list of additional side conditions, including receive time difference (RTD) at the UE side, power difference (at UE side) and quasi co-location (QCL) status. Taking RTD as an example, the RTD between the serving cell (e.g. PCell) and the intended/new/target/to be activated SCell may need to be within 260 ns (as observed by the UE), which is rather smaller than the maximum allowed maximum received time difference (MRTD), which is 33 us for the inter-band CA (38.133 section 7.6.4):
“ . . . For inter-band NR carrier aggregation,
   the UE shall be capable of handling at least a relative receive timing difference between slot timing of all pairs of carriers in FR1 and FR2-1 to be aggregated at the UE receiver as shown in Table 7.6.4-2 below.
   the UE shall be capable of handling at least a relative receive timing difference between subframe timing of all pairs of carriers in FR1 and FR2-2 to be aggregated at the UE receiver as shown in Table 7.6.4-2 below . . . ”

The referenced table 7.6.4-2: Maximum receive timing difference requirement for inter-band NR carrier aggregation, is here reproduced as TABLE 1:

TABLE 1

| Frequency Range of the | Maximum receive timing |
|---|---|
| pair of carriers | difference (μs) |
| FR1 | 33 |
| FR2-1 | 8 ^{note1} |
| Between FR1 and FR2-1 | 25 |
| Between FR1 and FR2-2 | 25 |

^{Note1}:
This requirement applies to the UE capable of independent beam management for FR2-1 inter-band CA.

The current 260 ns MRTD requirement is based on intra-band contiguous CA, where the current MRTD is based on the network phase synchronization requirement of 260 ns, and assuming that the PL delay difference between the PCell and the SCell being activated is negligible (e.g. zero).

Directly applying similar requirement(s) for inter-band CA may not be straight forward, as FR1 covers a wide frequency range where the path loss (PL) delay, reflections, and PL loss may differ between the carriers used in CA (e.g. 900 MHz and 6 GHz). This may mean that not all the inter-band SCells may fulfill the currently defined side conditions, and so only certain SCells can be activated reusing PCell information. It is not discussed or defined how to activate the SSB-less SCell if any of the side conditions are not fulfilled. It is also unclear what would be the UE behavior if the SCell activation is not possible due to current side conditions not being fulfilled.

Looking at these side conditions, the QCL information and assumption is configured by the network based on the network deployment and assumptions (but is, however, used by the UE). The RTD and power difference conditions are determined by the UE based on the UE conditions at the SCell activation time, and is only known to the UE. Additionally, how these side conditions are determined by the UE (if at all evaluated by the UE) is left up to the UE implementation. The network does not currently know if one, some, or all of the side conditions are fulfilled, and accordingly does not know if the 3 ms activation delay requirement can apply.

In practice, and in practical deployments, when activating an SSB-less SCell, the network would have to wait for the ‘valid’ channel status report (CSI) for the SCell without knowing when/if the CSI report will be received. Hence, the current approach is a trial and error approach, which is not system efficient. In case the ‘valid’ indication, or any CSI report, is not received by the network, the network does not know if the CSI report is lost, or if it was not even sent by the UE.

Features as described herein may be discussed in the context of an ongoing 3GPP NR WI based on inter-band collocated PCells and SCells, as above. However, this is a nonlimiting example; scenarios in NR and 6G may also be possible.

In an example embodiment, the UE may send an SCell activation success/failure indication to the network at the time when the SCell is activated by the network. In an example embodiment, a failure indication may be indicated when one or more of the necessary conditions for activating are not fulfilled on the UE side. In an example embodiment, a success indication may be indicated when one or more of the necessary conditions for activating are fulfilled on the UE side. The network may start scheduling the UE when/upon/after receiving this success indication.

In an example embodiment, based on the immediate UE feedback upon SCell activation, the network may determine the activation steps based on the activation failure or success indication. Optionally, the failure/success indication may need to be transmitted within a time period after receiving the SCell activation command. Otherwise, if the network has not received the failure/success indication within the time period, the network may by default assume that the side conditions are fulfilled, and that the SCell activation procedure is continuing/ongoing (hence, it is a success).

In an example embodiment, the UE may send the activation failure indication if some of the side conditions are not fulfilled. When receiving the failure indication, the network may determine/understand that the UE cannot activate the SCell, for example because the side conditions for reuse of the PCell or other SCell information for activating the SSB-less SCell are not fulfilled (e.g. are at least partially different).

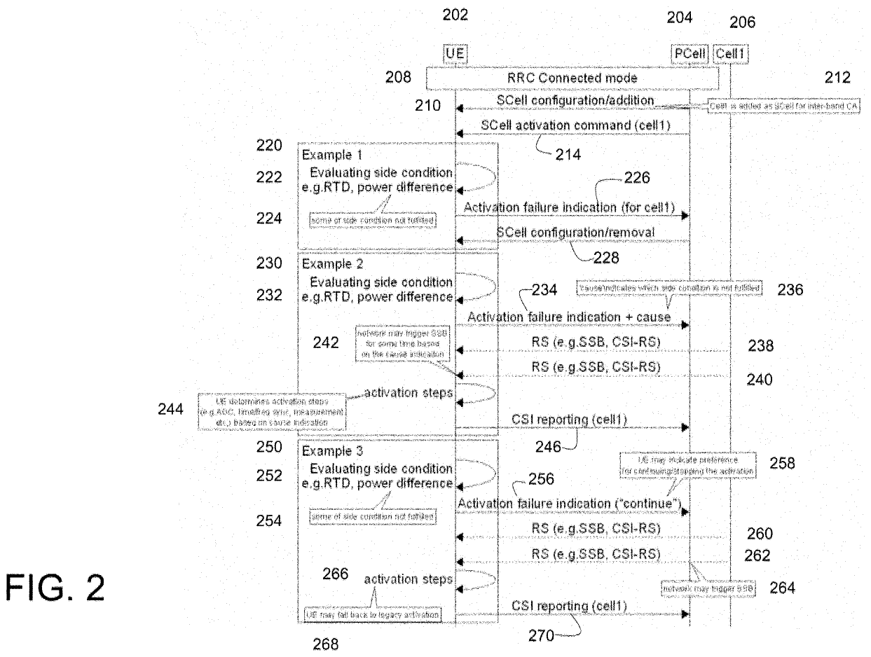

In an example embodiment, a failure indication may be used by the network to, for example, trigger one or more reference signals, for example SSB and/or CSI-RS transmissions on the intended/new/target/to be activated SCell for some time so as to help the SCell activation (i.e. assistance SSB transmission). Alternatively, the network may stop activating the SSB-less SCell and de-configure/remove the SCell from inter-band CA. In an example embodiment, the UE may stop/cancel the SCell activation procedure, for example via SCell reconfiguration or SCell removal message, if the UE indicates activation failure to the network (see, e.g., Example 1 (220) of FIG. 2).

In an example embodiment, the UE may further indicate which of the side condition is not fulfilled (see, e.g., Example 2 (230) of FIG. 2). For example, the UE may not be able to activate the SCell because RTD observed by the UE exceeds a threshold, or because a power difference observed by the UE between the serving cell and the intended/new/target/to be activated SCell is not within a threshold, or because the SNR of the intended/new/target/to be activated SCell is below a threshold, or for any combination of these reasons.

In an example embodiment, assistance/cause information may help the network to better understand the conditions at UE side in order to align with the activation behavior at the UE (see, e.g., Example 2 (230) of FIG. 2). For example, if the UE indicates that the failure is due to RTD exceeding a threshold, but the power difference condition is fulfilled, this may imply that the PCell timing cannot be reused, but AGC may be set referring to PCell power setting(s). In this case, the network may trigger single SSB or CSI-RS to help the UE for time/frequency synchronization on the SSB-less SCell in order to activate the SCell. In another example, if the UE indicates that the failure is due to power difference not being within a threshold, but the RTD condition is fulfilled, this may imply that the timing is well maintained between PCell and SCell, and hence the PCell timing may be reused. In this case, the network may trigger at least two SSB or CSI-RS to help the UE for AGC on the SSB-less SCell in order to activate the SCell. A longer activation delay may be expected. In another example, if the UE indicates that the failure is because neither of the power nor the RTD conditions are fulfilled, this may imply that the UE may not reuse the PCell information for SCell activation. In this case, the network may trigger more SSB or CSI-RS to help the UE for legacy SCell activation. In another example, if the UE indicates that the failure is due to SNR of the intended/new/target/to be activated SCell being below a threshold, it may mean that the SCell activation delay requirement cannot be fulfilled hence the network may stop the SCell activation and remove or de-configure the SCell from the cell list.

In an example embodiment, the assistance/cause information may help the network to take appropriate actions, such as deactivating the SCell (or even de-configuring or removing the SCell from the CA list). This may have the technical effect of helping both the network (which may release all related reserved resources for the SCell, for example in the PCell UL) and UE, which may not have to measure the activated/deactivated SCell.

In an example embodiment, the UE may indicate a preference for whether the network shall trigger SSB to continue the activation. For instance, the UE may suggest terminating the activation procedure. In response to the suggestion, the network may not trigger SSB on the SSB-less SCell, and instead de-configure the SCell.

Referring now to FIG. 2, illustrated is an example of activation status (success/failure) indication and the following activation procedure. At 208, the UE (202) may be connected with a PCell (204). At 210, a cell may be added as a SCell (206), for example via RRC configuration message, and the UE may be operating in carrier aggregation (212) with a configured deactivated SCell (206). For example, Cell1 (206) may be added as a Scell for inter-band CA. As a default setting, Cell1 (206) may be in a deactivated state when being added. Alternatively, Cell1 (206) may be configured as activated. At 214, the network (204) may send, to the UE (202), an SCell activation command to activate the SCell (206).

In the example 1 (220), at 222 the UE (202) may evaluate the side conditions, including RTD, power difference, SNR etc. At 224, if any of the side conditions are not fulfilled, at 226 the UE (202) may initiate an activation status indication indicating ‘failure’ to the network (204). In other words, based on a status of at least one of the side conditions, the UE (202) may transmit an activation status indication. This may indicate to the network (204) that the SCell (206) cannot be activated properly. As a result, the network (204) may know/determine that the activation of the SCell (206) was not successful, and at 228 may stop the activation and/or remove the SCell from a CA list. In one alternative, the SCell (206) may remain on the CA list, and the UE (202) may keep the SCell (206) in a semi-activated state where the UE (202) may continue to activate the SCell (e.g. by evaluating when the conditions for activation are fulfilled), and the UE (202) may indicate the status (success) to the network (204) once the SCell (206) is activated. In another alternative, the UE (202) may initiate an activation status indication indicating ‘success’ to the network (204) if any of the side conditions are fulfilled (e.g. RTD is fulfilled). This may indicate that the activation procedure is ongoing, and the network may start scheduling the UE upon receiving the ‘success’ indication.

In an example embodiment, the UE may send an activation status indication when at least one condition for the activation of the SCell is not met. Alternatively, the UE may send an activation status indication when at least one condition for the activation of the SCell is met. Alternatively, the UE may send an activation status indication regardless of whether at least one condition for the activation of the SCell is or is not met; in other words, the activation status indication may always be sent after evaluation of the a least one condition for activation.

In the example 2 (230), at 232 the UE (202) may evaluate the side conditions, including RTD, power difference, SNR etc. If any of the side conditions are not fulfilled, at 234 the UE (202) may initiate an activation status indication indicating ‘failure’ to the network (204), and at 236 may further indicate the cause of the activation failure (e.g. if the SCell activation failed due to RTD condition, power imbalance condition, and/or SNR conditions). When receiving the failure indication from the UE (202), the network (204) may take appropriate actions. Such actions may, for example, be triggering the transmission of ‘assistance’ reference signals (RSs) (e.g. SSB or CSI-RS) for some time to assist the UE in activation of the SCell (e.g. SSB and/or CSI-RS at 238/240). For example, the Cell1 (206) may, optionally, at 238 and 240, transmit RS to the UE (202). The RSs and/or how long the RS (e.g. SSB) will be transmitted may be determined based on the cause (242). For example, if the activation failure is due to RTD, the network (204) may trigger sending of one or more SSB for the UE (202) to acquire the time and frequency synchronization. For example, if the activation failure is due to power imbalance, the network (204) may trigger sending of one or more, for example at least 2, SSBs for the UE (202) to do AGC. For example, if the activation failure is due to both RTD and power imbalance, the network (204) may trigger sending of one or more SSB for the UE (202) to acquire the time and frequency synchronization or measurement accuracy. For example, if the activation failure is due to SNR, the network may stop the SCell activation and de-configure or remove the SCell (206). After receiving the RS(s), the UE (202) may determine and perform activation steps (e.g. AGC, time/frequency synchronization, measurement, etc.) based on the cause indication. At 246, the UE (202) may transmit, to the PCell (204), CSI reporting with regard to the Cell1 (206) indicating the completion of the SCell activation procedure. In one alternative embodiment, the UE may indicate activation success to the network.

In the example 3 (250), at 252 the UE (202) may evaluate the side conditions, including RTD, power difference, SNR etc. If any of the side conditions are not fulfilled (254), at 256 the UE (202) may initiate an activation status indication indicating ‘failure’ to the network (204), and at 258 may further indicate its preference for continuing or stopping the activation procedure, or may indicate preferred type of assistance RS (e.g. SSB or CSI-RS) or preferred assistance RS (e.g. index of RS(s)). If the UE (202) indicates to continue despite failure, at 264 the network (204) may trigger transmission of assistance SSB or CSI-RS (e.g. 260, 262) (potentially according to UE (202) indicated preference, if such is given) so that the UE (202) may fall back to legacy activation procedure(s). At 266, the UE (202) may determine and perform activation steps. For example, at 268 the UE (202) may fall back to legacy activation procedure(s) based on the assistance RS transmitted on Cell1. At 270, the UE (202) may transmit, to the PCell (204), CSI reporting with regard to the Cell1 (206). In one alternative embodiment, the UE may indicate activation success to the network.

Example embodiments of the present disclosure may be applicable to sidelink UEs, for example in a scenario in which a network or cell switches off/on for a UE configured to perform sidelink (SL) operations. NR SL methods may be implemented to provide communication between a vehicle and a network, infrastructure(s), other vehicle(s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may relate to Internet of Things

(IoT) and automotive industries (e.g., for reduction of accident risk and safer driving experiences). These use cases may include a message exchange among vehicles (V2V), vehicles and pedestrians (V2P), vehicles and infrastructure (V2I), and/or vehicles and networks (V2N), and may be referred to as vehicle-to-everything (V2X). The allocation of V2V resources in cellular, i.e., time and frequency resources, can be either controlled by the cellular network structure or performed autonomously by the individual vehicles (e.g. UE devices thereof). Sidelink may use same or different carrier frequencies or frequency bands than cellular communication.

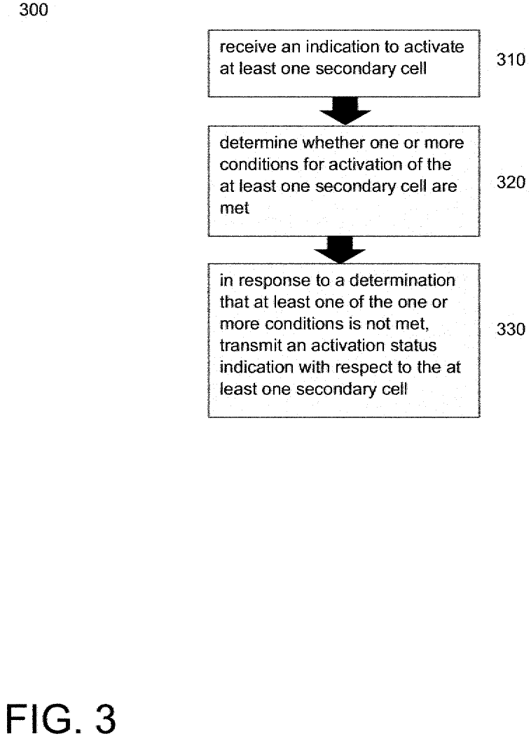

FIG. 3 illustrates the potential steps of an example method 300. The example method 300 may include: receiving an indication to activate at least one secondary cell, 310; determining whether one or more conditions for activation of the at least one secondary cell are met, 320; and in response to a determination that at least one of the one or more conditions is not met, transmit an activation status indication with respect to the at least one secondary cell, 330. The example method 300 may be performed, for example, with a UE. The method 300 may be applied to SCG as well as to SCell. The SCG may comprise a PSCell.

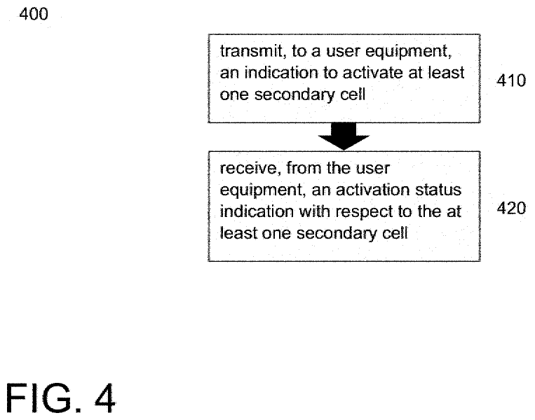

FIG. 4 illustrates the potential steps of an example method 400. The example method 400 may include: transmitting, to a user equipment, an indication to activate at least one secondary cell, 410; and receiving, from the user equipment, an activation status indication with respect to the at least one secondary cell, 420. The example method 400 may be performed, for example, with a PCell, base station, network element, gNB, eNB, etc. The method 400 may be applied to SCG as well as to SCell. The SCG may comprise a PSCell.

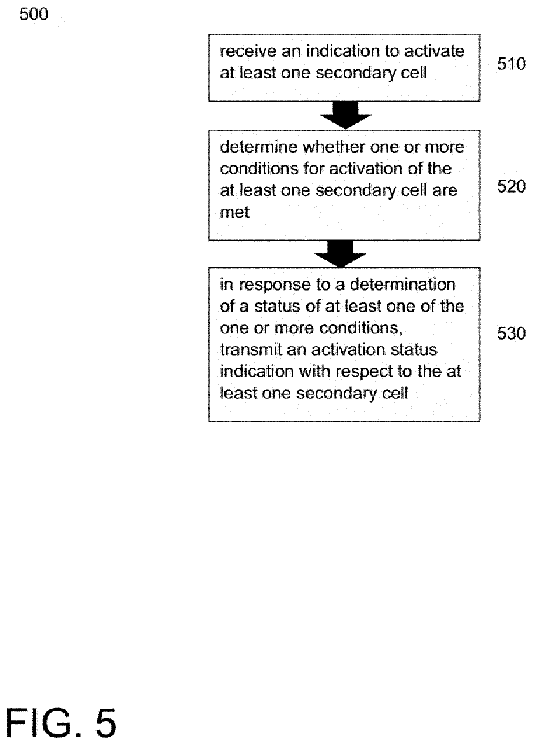

FIG. 5 illustrates the potential steps of an example method 500. The example method 500 may include: receiving, with a user equipment, an indication to activate at least one secondary cell, 510; determining whether one or more conditions for activation of the at least one secondary cell are met, 520; and in response to a determination of a status of at least one of the one or more conditions, transmitting an activation status indication with respect to the at least one secondary cell, 530. The example method 500 may be performed, for example, with a UE. The method 500 may be applied to SCG as well as to SCell. The SCG may comprise a PSCell.

In accordance with one example embodiment, an apparatus may comprise: at least one processor; and at least one memory storing instructions that, when executed by the at least one processor, cause the apparatus at least to: receive an indication to activate at least one secondary cell; determine whether one or more conditions for activation of the at least one secondary cell are met; and in response to a determination that at least one of the one or more conditions is not met, transmit an activation status indication with respect to the at least one secondary cell.

The one or more conditions for activation of the at least one secondary cell may comprise at least one of: a receive time difference condition, a timing condition, a channel propagation condition, a power difference condition, a quasi co-location condition, a beam information condition, or a signal to noise ratio condition.

The activation status indication may be transmitted within a predetermined time period after the receiving of the indication to activate the at least one secondary cell.

The activation status indication may be configured to indicate activation failure, wherein the example apparatus may be further configured to: receive, in response to the activation status indication, an indication that the at least one secondary cell has been one of: de-configured, deactivated, or removed from a carrier aggregation list.

The activation status indication may be configured to indicate activation failure.

The activation status indication may comprise, at least, an indication of the at least one of the one or more conditions that is not met.

The activation status indication may be configured to indicate activation failure and may comprise, at least, an indication to continue the activation of the at least one secondary cell.

The activation status indication may be configured to indicate activation failure and may comprise, at least, an indication to trigger the at least one secondary cell to transmit at least one synchronization signal block or at least one channel state information reference signal.

The activation status indication may be configured to indicate activation failure and may comprise, at least, an indication of at least one of: a preferred assistance reference signal, a preferred type of assistance reference signal, or an index of the preferred assistance reference signal.

The example apparatus may be further configured to: receive at least one reference signal from the at least one secondary cell.

The at least one reference signal may comprise at least one of: a synchronization signal block, or a channel state information reference signal.

The example apparatus may be further configured to: determine to perform at least one activation step based, at least partially, on the at least one of the one or more conditions that is not met, wherein the at least one activation step may comprise at least one of: time and frequency synchronization with the at least one secondary cell, automatic gain control with the at least one secondary cell, channel measurement, or activation of the at least one secondary cell based on one or more synchronization signal blocks.

The example apparatus may be further configured to: continue monitoring the one or more conditions for activation of the at least one secondary cell; and in response to a determination that the one or more conditions are met, transmit an activation status indication configured to indicate activation success with respect to the at least one secondary cell.

The example apparatus may be further configured to: in response to a determination that at least one of the one or more conditions is met, transmit an activation status indication to indicate activation success.

The activation status indication to indicate activation success may comprise, at least, an indication of at least one of the one or more conditions that is met.

The example apparatus may be further configured to: receive network scheduling in response to the at least one of the one or more conditions that is met.

The activation status indication may be configured to indicate activation failure and may comprise, at least, an indication to stop the activation of the at least one secondary cell.

In accordance with one aspect, an example method may be provided comprising: receiving, with a user equipment, an indication to activate at least one secondary cell; determining whether one or more conditions for activation of the at least one secondary cell are met; and in response to a determination that at least one of the one or more conditions is not met, transmitting an activation status indication with respect to the at least one secondary cell.

The one or more conditions for activation of the at least one secondary cell may comprise at least one of: a receive time difference condition, a timing condition, a channel propagation condition, a power difference condition, a quasi co-location condition, a beam information condition, or a signal to noise ratio condition.

The activation status indication may be transmitted within a predetermined time period after the receiving of the indication to activate the at least one secondary cell.

The activation status indication may be configured to indicate activation failure, further comprising: receiving, in response to the activation status indication, an indication that the at least one secondary cell has been one of: de-configured, deactivated, or removed from a carrier aggregation list.

The activation status indication may be configured to indicate activation failure.

The activation status indication may comprise, at least, an indication of the at least one of the one or more conditions that is not met.

The activation status indication may be configured to indicate activation failure and may comprise, at least, an indication to continue the activation of the at least one secondary cell.

The activation status indication may be configured to indicate activation failure and may comprise, at least, an indication to trigger the at least one secondary cell to transmit at least one synchronization signal block or at least one channel state information reference signal.

The activation status indication may be configured to indicate activation failure and may comprise, at least, an indication of at least one of: a preferred assistance reference signal, a preferred type of assistance reference signal, or an index of the preferred assistance reference signal.

The example method may further comprise: receiving at least one reference signal from the at least one secondary cell.

The at least one reference signal may comprise at least one of: a synchronization signal block, or a channel state information reference signal.

The example method may further comprise: determining to perform at least one activation step based, at least partially, on the at least one of the one or more conditions that is not met, wherein the at least one activation step may comprise at least one of: time and frequency synchronization with the at least one secondary cell, automatic gain control with the at least one secondary cell, channel measurement, or activation of the at least one secondary cell based on one or more synchronization signal blocks.

The example method may further comprise: continuing monitoring of the one or more conditions for activation of the at least one secondary cell; and in response to a determination that the one or more conditions are met, transmitting an activation status indication configured to indicate activation success with respect to the at least one secondary cell.

The example method may further comprise: in response to a determination that at least one of the one or more conditions is met, transmitting an activation status indication to indicate activation success.

The activation status indication to indicate activation success may comprise, at least, an indication of at least one of the one or more conditions that is met.

The example method may further comprise: receiving network scheduling in response to the at least one of the one or more conditions that is met.

The activation status indication may be configured to indicate activation failure and may comprise, at least, an indication to stop the activation of the at least one secondary cell.

In accordance with one example embodiment, an apparatus may comprise: circuitry configured to perform: receiving, with a user equipment, an indication to activate at least one secondary cell; circuitry configured to perform: determining whether one or more conditions for activation of the at least one secondary cell are met; and circuitry configured to perform: in response to a determination that at least one of the one or more conditions is not met, transmitting an activation status indication with respect to the at least one secondary cell.

In accordance with one example embodiment, an apparatus may comprise: processing circuitry; memory circuitry including computer program code, the memory circuitry and the computer program code configured to, with the processing circuitry, enable the apparatus to: receive an indication to activate at least one secondary cell; determine whether one or more conditions for activation of the at least one secondary cell are met; and in response to a determination that at least one of the one or more conditions is not met, transmit an activation status indication with respect to the at least one secondary cell.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving an indication to activate at least one secondary cell; determining whether one or more conditions for activation of the at least one secondary cell are met; and in response to a determination that at least one of the one or more conditions is not met, transmitting an activation status indication with respect to the at least one secondary cell.

The one or more conditions for activation of the at least one secondary cell may comprise at least one of: a receive time difference condition, a timing condition, a channel propagation condition, a power difference condition, a quasi co-location condition, a beam information condition, or a signal to noise ratio condition.

The activation status indication may be transmitted within a predetermined time period after the receiving of the indication to activate the at least one secondary cell.

The activation status indication may be configured to indicate activation failure, wherein the means may be further configured to perform: receiving, in response to the activation status indication, an indication that the at least one secondary cell has been one of: de-configured, deactivated, or removed from a carrier aggregation list.

The activation status indication may be configured to indicate activation failure.

The activation status indication may comprise, at least, an indication of the at least one of the one or more conditions that is not met.

The activation status indication may be configured to indicate activation failure and may comprise, at least, an indication to continue the activation of the at least one secondary cell.

The activation status indication may be configured to indicate activation failure and may comprise, at least, an indication to trigger the at least one secondary cell to transmit at least one synchronization signal block or at least one channel state information reference signal.

The activation status indication may be configured to indicate activation failure and may comprise, at least, an indication of at least one of: a preferred assistance reference signal, a preferred type of assistance reference signal, or an index of the preferred assistance reference signal.

The means may be further configured to perform: receiving at least one reference signal from the at least one secondary cell.

The at least one reference signal may comprise at least one of: a synchronization signal block, or a channel state information reference signal.

The means may be further configured to perform: determining to perform at least one activation step based, at least partially, on the at least one of the one or more conditions that is not met, wherein the at least one activation step comprises at least one of: time and frequency synchronization with the at least one secondary cell, automatic gain control with the at least one secondary cell, channel measurement, or activation of the at least one secondary cell based on one or more synchronization signal blocks.

The means may be further configured to perform: continuing monitoring of the one or more conditions for activation of the at least one secondary cell; and in response to a determination that the one or more conditions are met, transmitting an activation status indication configured to indicate activation success with respect to the at least one secondary cell.

The means may be further configured to perform: in response to a determination that at least one of the one or more conditions is met, transmitting an activation status indication to indicate activation success.

The activation status indication to indicate activation success may comprise, at least, an indication of at least one of the one or more conditions that is met.

The means may be further configured to perform: receiving network scheduling in response to the at least one of the one or more conditions that is met.

The activation status indication may be configured to indicate activation failure and may comprise, at least, an indication to stop the activation of the at least one secondary cell.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause receiving of an indication to activate at least one secondary cell; determine whether one or more conditions for activation of the at least one secondary cell are met; and in response to a determination that at least one of the one or more conditions is not met, cause transmitting of an activation status indication with respect to the at least one secondary cell.

In accordance with one example embodiment, a non-transitory computer-readable medium comprising program instructions stored thereon for performing at least the following: causing receiving of an indication to activate at least one secondary cell; determining whether one or more conditions for activation of the at least one secondary cell are met; and in response to a determination that at least one of the one or more conditions is not met, causing transmitting of an activation status indication with respect to the at least one secondary cell.

In accordance with another example embodiment, a non-transitory program storage device readable by a machine may be provided, tangibly embodying instructions executable by the machine for performing operations, the operations comprising: causing receiving of an indication to activate at least one secondary cell; determining whether one or more conditions for activation of the at least one secondary cell are met; and in response to a determination that at least one of the one or more conditions is not met, causing transmitting of an activation status indication with respect to the at least one secondary cell.

In accordance with another example embodiment, a non-transitory computer-readable medium comprising instructions that, when executed by an apparatus, cause the apparatus to perform at least the following: causing receiving of an indication to activate at least one secondary cell; determining whether one or more conditions for activation of the at least one secondary cell are met; and in response to a determination that at least one of the one or more conditions is not met, causing transmitting of an activation status indication with respect to the at least one secondary cell.

A computer implemented system comprising: at least one processor and at least one non-transitory memory storing instructions that, when executed by the at least one processor, cause the system at least to perform: causing receiving of an indication to activate at least one secondary cell; determining whether one or more conditions for activation of the at least one secondary cell are met; and in response to a determination that at least one of the one or more conditions is not met, causing transmitting of an activation status indication with respect to the at least one secondary cell.

A computer implemented system comprising: means for causing receiving of an indication to activate at least one secondary cell; means for determining whether one or more conditions for activation of the at least one secondary cell are met; and means for in response to a determination that at least one of the one or more conditions is not met, causing transmitting of an activation status indication with respect to the at least one secondary cell.

In accordance with one example embodiment, an apparatus may comprise: at least one processor; and at least one memory storing instructions that, when executed by the at least one processor, cause the apparatus at least to: transmit, to a user equipment, an indication to activate at least one secondary cell; and receive, from the user equipment, an activation status indication with respect to the at least one secondary cell.

The activation status indication may be received within a predetermined time period after the transmitting of the indication to activate the at least one secondary cell.

The activation status indication may be configured to indicate activation failure, wherein the example apparatus may be further configured to: transmit, to the user equipment in response to the activation status indication, an indication that the at least one secondary cell has been one of: de-configured, deactivated, or removed from a carrier aggregation list.

The activation status indication may be configured to indicate activation failure and may comprise, at least, an indication of at least one of one or more conditions for activation of the at least one secondary cell that is not met, wherein the one or more conditions may comprise at least one of: a receive time difference condition, a timing condition, a channel propagation condition, a power difference condition, a quasi co-location condition, a beam information condition, or a signal to noise ratio condition.

The activation status indication may be configured to indicate activation failure and may comprise, at least, an indication to continue the activation of the at least one secondary cell.

The activation status indication may be configured to indicate activation failure and may comprise, at least, an indication to trigger the at least one secondary cell to transmit at least one synchronization signal block or at least one channel state information reference signal.

The activation status indication may be configured to indicate activation failure and may comprise, at least, an indication of at least one of: a preferred assistance reference signal, a preferred type of assistance reference signal, or an index of the preferred assistance reference signal.

The example apparatus may be further configured to: in response to the activation status indication, cause the at least one secondary cell to transmit at least one reference signal to the user equipment.

The activation status indication may comprise, at least, an indication of at least one of one or more conditions for activation of the at least one secondary cell that is not met, wherein the example apparatus may be further configured to: determine a type of the at least one reference signal based, at least partially, on the at least one of the one or more conditions for activation of the at least one secondary cell that is not met.

The activation status indication may comprise, at least, an indication of at least one of one or more conditions for activation of the at least one secondary cell that is not met, wherein the example apparatus may be further configured to: determine a duration of the at least one reference signal based, at least partially, on the at least one of the one or more conditions for activation of the at least one secondary cell that is not met.

The activation status indication may comprise, at least, an indication that a receive time difference condition is not met for the at least one secondary cell, wherein the example apparatus may be further configured to: cause the at least one secondary cell to transmit one reference signal to the user equipment.

The activation status indication may comprise, at least, an indication that a power difference condition is not met for the at least one secondary cell, wherein the example apparatus may be further configured to: cause the at least one secondary cell to transmit at least two reference signals to the user equipment.

The activation status indication may comprise, at least, an indication that a power difference condition is not met for the at least one secondary cell and a receive time difference condition is not met for the at least one secondary cell, wherein the example apparatus may be further configured to: cause the at least one secondary cell to transmit at least one reference signal to the user equipment.

The activation status indication may comprise, at least, an indication that a signal to noise ratio condition is not met for the at least one secondary cell, wherein the example apparatus may be further configured to: cause the at least one secondary cell to transmit at least one reference signal to the user equipment.

The activation status indication may comprise, at least, an indication that a signal to noise ratio condition is not met for the at least one secondary cell, wherein the example apparatus may be further configured to: stop the activation of the at least one secondary cell.

The activation status indication may be configured to indicate activation success and may comprise, at least, an indication of at least one of one or more conditions that is met.

The example apparatus may be further configured to: transmit, to the user equipment, scheduling in response to the at least one of the one or more conditions that is met.

The activation status indication may comprise, at least, an indication to stop the activation of the at least one secondary cell.

In accordance with one aspect, an example method may be provided comprising: transmitting, to a user equipment, an indication to activate at least one secondary cell; and receiving, from the user equipment, an activation status indication with respect to the at least one secondary cell.

The activation status indication may be received within a predetermined time period after the transmitting of the indication to activate the at least one secondary cell.

The activation status indication may be configured to indicate activation failure, further comprising: transmitting, to the user equipment in response to the activation status indication, an indication that the at least one secondary cell has been one of: de-configured, deactivated, or removed from a carrier aggregation list.

The activation status indication may be configured to indicate activation failure and may comprise, at least, an indication of at least one of one or more conditions for activation of the at least one secondary cell that is not met, wherein the one or more conditions may comprise at least one of: a receive time difference condition, a timing condition, a channel propagation condition, a power difference condition, a quasi co-location condition, a beam information condition, or a signal to noise ratio condition.

The activation status indication may be configured to indicate activation failure and may comprise, at least, an indication to continue the activation of the at least one secondary cell.

The activation status indication may be configured to indicate activation failure and may comprise, at least, an indication to trigger the at least one secondary cell to transmit at least one synchronization signal block or at least one channel state information reference signal.

The activation status indication may be configured to indicate activation failure and may comprise, at least, an indication of at least one of: a preferred assistance reference signal, a preferred type of assistance reference signal, or an index of the preferred assistance reference signal.

The example method may further comprise: in response to the activation status indication, causing the at least one secondary cell to transmit at least one reference signal to the user equipment.

The activation status indication may comprise, at least, an indication of at least one of one or more conditions for activation of the at least one secondary cell that is not met, further comprising: determining a type of the at least one reference signal based, at least partially, on the at least one of the one or more conditions for activation of the at least one secondary cell that is not met.

The activation status indication may comprise, at least, an indication of at least one of one or more conditions for activation of the at least one secondary cell that is not met, further comprising: determining a duration of the at least one reference signal based, at least partially, on the at least one of the one or more conditions for activation of the at least one secondary cell that is not met.

The activation status indication may comprise, at least, an indication that a receive time difference condition is not met for the at least one secondary cell, further comprising: causing the at least one secondary cell to transmit one reference signal to the user equipment.

The activation status indication may comprise, at least, an indication that a power difference condition is not met for the at least one secondary cell, further comprising: causing the at least one secondary cell to transmit at least two reference signals to the user equipment.

The activation status indication may comprise, at least, an indication that a power difference condition is not met for the at least one secondary cell and a receive time difference condition is not met for the at least one secondary cell, further comprising: causing the at least one secondary cell to transmit at least one reference signal to the user equipment.

The activation status indication may comprise, at least, an indication that a signal to noise ratio condition is not met for the at least one secondary cell, further comprising: causing the at least one secondary cell to transmit at least one reference signal to the user equipment.

The activation status indication may comprise, at least, an indication that a signal to noise ratio condition is not met for the at least one secondary cell, further comprising: stopping the activation of the at least one secondary cell.

The activation status indication may be configured to indicate activation success and may comprise, at least, an indication of at least one of one or more conditions that is met.

The example method may further comprise: transmitting, to the user equipment, scheduling in response to the at least one of the one or more conditions that is met.

The activation status indication may comprise, at least, an indication to stop the activation of the at least one secondary cell.

In accordance with one example embodiment, an apparatus may comprise: circuitry configured to perform: transmitting, to a user equipment, an indication to activate at least one secondary cell; and circuitry configured to perform: receiving, from the user equipment, an activation status indication with respect to the at least one secondary cell.

In accordance with one example embodiment, an apparatus may comprise: processing circuitry; memory circuitry including computer program code, the memory circuitry and the computer program code configured to, with the processing circuitry, enable the apparatus to: transmit, to a user equipment, an indication to activate at least one secondary cell; and receive, from the user equipment, an activation status indication with respect to the at least one secondary cell.

In accordance with one example embodiment, an apparatus may comprise means for performing: transmitting, to a user equipment, an indication to activate at least one secondary cell; and receiving, from the user equipment, an activation status indication with respect to the at least one secondary cell.

The activation status indication may be received within a predetermined time period after the transmitting of the indication to activate the at least one secondary cell.

The activation status indication may be configured to indicate activation failure, wherein the means may be further configured to perform: transmitting, to the user equipment in response to the activation status indication, an indication that the at least one secondary cell has been one of: de-configured, deactivated, or removed from a carrier aggregation list.

The activation status indication may be configured to indicate activation failure and may comprise, at least, an indication of at least one of one or more conditions for activation of the at least one secondary cell that is not met, wherein the one or more conditions may comprise at least one of: a receive time difference condition, a timing condition, a channel propagation condition, a power difference condition, a quasi co-location condition, a beam information condition, or a signal to noise ratio condition.

The activation status indication may be configured to indicate activation failure and may comprise, at least, an indication to continue the activation of the at least one secondary cell.

The activation status indication may be configured to indicate activation failure and may comprise, at least, an indication to trigger the at least one secondary cell to transmit at least one synchronization signal block or at least one channel state information reference signal.

The activation status indication may be configured to indicate activation failure and may comprise, at least, an indication of at least one of: a preferred assistance reference signal, a preferred type of assistance reference signal, or an index of the preferred assistance reference signal.

The means may be further configured to perform: in response to the activation status indication, causing the at least one secondary cell to transmit at least one reference signal to the user equipment.

The activation status indication may comprise, at least, an indication of at least one of one or more conditions for activation of the at least one secondary cell that is not met, wherein the means may be further configured to perform: determining a type of the at least one reference signal based, at least partially, on the at least one of the one or more conditions for activation of the at least one secondary cell that is not met.

The activation status indication may comprise, at least, an indication of at least one of one or more conditions for activation of the at least one secondary cell that is not met, wherein the means may be further configured to perform: determining a duration of the at least one reference signal based, at least partially, on the at least one of the one or more conditions for activation of the at least one secondary cell that is not met.

The activation status indication may comprise, at least, an indication that a receive time difference condition is not met for the at least one secondary cell, wherein the means may be further configured to perform: causing the at least one secondary cell to transmit one reference signal to the user equipment.

The activation status indication may comprise, at least, an indication that a power difference condition is not met for the at least one secondary cell, wherein the means may be further configured to perform: causing the at least one secondary cell to transmit at least two reference signals to the user equipment.

The activation status indication may comprise, at least, an indication that a power difference condition is not met for the at least one secondary cell and a receive time difference condition is not met for the at least one secondary cell, wherein the means may be further configured to perform: causing the at least one secondary cell to transmit at least one reference signal to the user equipment.

The activation status indication may comprise, at least, an indication that a signal to noise ratio condition is not met for the at least one secondary cell, wherein the means may be further configured to perform: causing the at least one secondary cell to transmit at least one reference signal to the user equipment.

The activation status indication may comprise, at least, an indication that a signal to noise ratio condition is not met for the at least one secondary cell, wherein the means may be further configured to perform: stopping the activation of the at least one secondary cell.

The activation status indication may be configured to indicate activation success and may comprise, at least, an indication of at least one of one or more conditions that is met.

The means may be further configured to perform: transmitting, to the user equipment, scheduling in response to the at least one of the one or more conditions that is met.

The activation status indication may comprise, at least, an indication to stop the activation of the at least one secondary cell.

In accordance with one example embodiment, a non-transitory computer-readable medium comprising instructions stored thereon which, when executed with at least one processor, cause the at least one processor to: cause transmitting, to a user equipment, of an indication to activate at least one secondary cell; and cause receiving, from the user equipment, of an activation status indication with respect to the at least one secondary cell.

In accordance with one example embodiment, a non-transitory computer-readable medium comprising program instructions stored thereon for performing at least the following: causing transmitting, to a user equipment, of an indication to activate at least one secondary cell; and causing receiving, from the user equipment, of an activation status indication with respect to the at least one secondary cell.

In accordance with another example embodiment, a non-transitory program storage device readable by a machine may be provided, tangibly embodying instructions executable by the machine for performing operations, the operations comprising: causing transmitting, to a user equipment, of an indication to activate at least one secondary cell; and causing receiving, from the user equipment, of an activation status indication with respect to the at least one secondary cell.

In accordance with another example embodiment, a non-transitory computer-readable medium comprising instructions that, when executed by an apparatus, cause the apparatus to perform at least the following: causing transmitting, to a user equipment, of an indication to activate at least one secondary cell; and causing receiving, from the user equipment, of an activation status indication with respect to the at least one secondary cell.

A computer implemented system comprising: at least one processor and at least one non-transitory memory storing instructions that, when executed by the at least one processor, cause the system at least to perform: causing transmitting, to a user equipment, of an indication to activate at least one secondary cell; and causing receiving, from the user equipment, of an activation status indication with respect to the at least one secondary cell.

A computer implemented system comprising: means for causing transmitting, to a user equipment, of an indication to activate at least one secondary cell; and means for causing receiving, from the user equipment, of an activation status indication with respect to the at least one secondary cell.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one non-transitory memory storing instructions that, when executed by the at least one processor, cause the apparatus at least to:
receive an indication to activate at least one secondary cell;
determine whether one or more conditions for activation of the at least one secondary cell are met; and
in response to a determination that at least one of the one or more conditions is not met, transmit an activation status indication with respect to the at least one secondary cell.

2. The apparatus of claim 1, wherein the one or more conditions for activation of the at least one secondary cell comprise at least one of:
a receive time difference condition,
a timing condition,
a channel propagation condition,
a power difference condition,
a quasi co-location condition,
a beam information condition, or
a signal to noise ratio condition.

3. The apparatus of claim 1, wherein the activation status indication is transmitted within a predetermined time period after the receiving of the indication to activate the at least one secondary cell.

4. The apparatus of claim 1, wherein the activation status indication is configured to indicate activation failure.

5. The apparatus of claim 4, wherein the activation status indication comprises, at least, an indication of the at least one of the one or more conditions that is not met.

6. The apparatus of claim 1, wherein the activation status indication is configured to indicate activation failure, wherein the at least one memory stores instructions that, when executed by the at least one processor, cause the apparatus to:
receive, in response to the activation status indication, an indication that the at least one secondary cell has been one of:
de-configured,
deactivated, or
removed from a carrier aggregation list.

7. The apparatus of claim 1, wherein the activation status indication is configured to indicate activation failure and comprises, at least, an indication to continue the activation of the at least one secondary cell.

8. The apparatus of claim 1, wherein the activation status indication is configured to indicate activation failure and comprises, at least, an indication to trigger the at least one secondary cell to transmit at least one synchronization signal block or at least one channel state information reference signal.

9. The apparatus of claim 1, wherein the activation status indication is configured to indicate activation failure and comprises, at least, an indication of at least one of:
a preferred assistance reference signal,
a preferred type of assistance reference signal, or
an index of the preferred assistance reference signal.

10. The apparatus of claim 4, wherein the at least one memory stores instructions that, when executed by the at least one processor, cause the apparatus to:
receive at least one reference signal from the at least one secondary cell.

11. The apparatus of claim 10, wherein the at least one reference signal comprises at least one of:
a synchronization signal block, or
a channel state information reference signal.

12. The apparatus of claim 4, wherein the at least one memory stores instructions that, when executed by the at least one processor, cause the apparatus to:
determine to perform at least one activation step based, at least partially, on the at least one of the one or more conditions that is not met, wherein the at least one activation step comprises at least one of:
time and frequency synchronization with the at least one secondary cell,
automatic gain control with the at least one secondary cell,
channel measurement, or
activation of the at least one secondary cell based on one or more synchronization signal blocks.

13. The apparatus of claim 4, wherein the at least one memory stores instructions that, when executed by the at least one processor, cause the apparatus to:
continue monitoring the one or more conditions for activation of the at least one secondary cell; and
in response to a determination that the one or more conditions are met, transmit an activation status indication configured to indicate activation success with respect to the at least one secondary cell.

14. The apparatus of claim 1, wherein the at least one memory stores instructions that, when executed by the at least one processor, cause the apparatus to:
in response to a determination that at least one of the one or more conditions is met, transmit an activation status indication to indicate activation success.

15. The apparatus of claim 14, wherein the activation status indication to indicate activation success comprises, at least, an indication of at least one of the one or more conditions that is met.

16. The apparatus of claim 14, wherein the at least one memory stores instructions that, when executed by the at least one processor, cause the apparatus to:
receive network scheduling in response to the at least one of the one or more conditions that is met.

17. The apparatus of claim 1, wherein the activation status indication is configured to indicate activation failure and comprises, at least, an indication to stop the activation of the at least one secondary cell.

18. A method comprising:
receiving, with a user equipment, an indication to activate at least one secondary cell;
determining whether one or more conditions for activation of the at least one secondary cell are met; and
in response to a determination that at least one of the one or more conditions is not met, transmitting an activation status indication with respect to the at least one secondary cell.

19-36. (canceled)

37. An apparatus comprising:
at least one processor; and
at least one non-transitory memory storing instructions that, when executed by the at least one processor, cause the apparatus at least to:
transmit, to a user equipment, an indication to activate at least one secondary cell; and
receive, from the user equipment, an activation status indication with respect to the at least one secondary cell.

38. The apparatus of claim 37, wherein the activation status indication is received within a predetermined time period after the transmitting of the indication to activate the at least one secondary cell.

39-50. (canceled)
